(19) United States
(12) Patent Application Publication
(10) Pub. No.: US 2021/0155538 A1
(43) Pub. Date: May 27, 2021

(54) CHAMBERED THIN GLASS PRODUCT WITH COMPLEX SHAPE AND WITH INCREASED RESISTANCE AND THE PRODUCTION METHOD OF SAID GLASS PRODUCT

(71) Applicant: TURKIYE SISE VE CAM FABRIKALARI ANONIM SIRKETI, Tuzla/Istanbul (TR)

(72) Inventors: Ilkay SOKMEN, ITuzla/stanbul (TR); Ezgi Deniz KACAR, Gebze/Kocaeli (TR); Semin ATILGAN, Gebze/Kocaeli (TR); Duygu GULDIREN, Gebze/Kocaeli (TR); Osman Burak OKAN, Tuzla/Istanbul (TR)

(21) Appl. No.: 16/967,443

(22) PCT Filed: Nov. 10, 2018
(86) PCT No.: PCT/TR2018/050674

§ 371 Date: Aug. 5, 2020

(30) Foreign Application Priority Data
Feb. 5, 2018 (TR) 2018/01566

(51) Int. Cl. C03C 21/00; C03C 3/095; C03C 3/089; C03C 3/091; C03C 3/093; C03C 4/18; C03B 27/012

(52) U.S. Cl. CPC C03C 21/002; C03C 3/095; C03C 3/089; C03C 2204/00; C03C 3/093; C03C 4/18; C03B 27/012; C03C 3/091

(57) ABSTRACT

The present invention relates to a strengthening method developed for use in chambered glass products with complex shape and with thin walls and having crystalline structure and comprising SiO₂+B₂O₃ in the range of 68-74% by weight; AI₂O₃ in the range of 0-2% by weight; Fe₂O₃ in the range of 0-0.02% by weight; Na₂O in the range of 8.5-12% by weight; K₂O in the range of 5-9% by weight; CaO in the range of 5-9% by weight; MgO in the range of 0-0.5% by weight; BaO in the range of 0-4% by weight; ZnO in the range of 0-3% by weight; TiO₂ in the range of 0-0.05% by weight; Sb₂O₃ in the range of 0-0.25% by weight and Er₂O₃ in the range of 0-0.05% by weight.

### TECHNICAL FIELD

The present invention relates to a method for particularly increasing resistance of thin-walled glass bottle in crystalline class and for increasing resistance of thin-walled and thin-footed glass household goods.

### PRIOR ART

The usage of glass is limited due to the mechanically breaking characteristic of glass. The most important ways for increasing resistance are to eliminate faults on the surface or to prevent advancing of cracks. The most frequently used methods for this purpose are as follows:
Fire finishing,
Special coatings,
Lamination,
Application of compressive stress by means of thermal or chemical tempering.

Chemical tempering process is preferred for increasing resistance in thin glasses since the mechanical resistance of glass decreases due to reduced glass thickness and since thin glasses cannot theoretically reach the suitable mechanical resistance by means of thermal tempering. The chemical tempering process is based on ion exchange process and it is traditionally realized by means of immersion into the salt bath at a specific temperature (approximately 100° C. lower than Tg value of glass) and for a specific duration.

In the direction of aesthetical and lightness requirements of the final user, the body and inlet wall thicknesses of thin-walled glass bottle in crystalline class and thin-walled and thin-footed glass cup products are essentially approximately 2.0 mm or lower. Their resistances are increased by means of chemical tempering since they are complex shaped and since they are thin-walled. There are 3 different chemical tempering technologies.

It is substantially difficult to apply bath technology to glass bottles and glass cups. The basket system used in classical bath technology cannot be used in chemical tempering of glass bottles and glass cups. Because glass bottles and glass cups have a complex shape and a wide inner chamber. Due to this complex shape, salt may remain in the chambers of glass products and therefore;
Salt consumption will be excessive.
The molten salt, which remains in the chamber as a result of chemical tempering process, will form an unbalanced compression layer on the inner-outer surface of the product and this will decrease the impact resistance of products.

In the patents with numbers EP2022767B1, EP2284132A1, U.S. Pat. No. 8,906,506 B2, U.S. Pat. No. 4,206,253, the chemical tempering of glass vessels by means of spraying and strengthening of glass vessels are disclosed. However, chemical tempering by means of spraying has the following disadvantages:
Homogeneous application to the inner surface, outer surface and base region of complex shaped products is difficult
Salt may flow from the glass surface at high temperatures
The corrosive effects of salts are higher when compared with bath technology.

As a result, because of all of the abovementioned problems, an improvement is required in the related technical field.

### BRIEF DESCRIPTION OF THE INVENTION

The present invention relates to a chemical tempering method, for eliminating the above mentioned disadvantages and for bringing new advantages to the related technical field.

An object of the present invention is to provide a chemical tempering method which increases resistance of thin-walled glass bottles in crystalline class and resistance of thin-walled and thin-footed glass cups.

Another object of the present invention is to provide glass bottles and thin-walled and thin-footed glass cups whose resistance is increased.

In order to realize all of the abovementioned objects and the objects which are to be deducted from the detailed description below, the present invention is a strengthening method by means of chemical tempering compliant to bath technology, developed for use in thin-walled glass bottle and thin footed glass cups having crystalline composition and comprising SiO₂+B₂O₃ in the range of 68-74% by weight; Al₂O₃ in the range of 0-2% by weight; Fe₂O₃ in the range of 0-0.02% by weight; Na₂O in the range of 8.5-12% by weight; K₂O in the range of 5-9% by weight; CaO in the range of 5-9% by weight; MgO in the range of 0-0.5% by weight; BaO in the range of 0-4% by weight; ZnO in the range of 0-3% by weight; TiO₂ in the range of 0-0.05% by weight; Sb₂O₃ in the range of 0-0.25% by weight and Er₂O₃ in the range of 0-0.05% by weight. Accordingly, said invention is characterized by comprising the following steps:
(a) Cleaning the glass product to be tempered and placing and fixing of the glass product into baskets such that the chamber of said glass product faces upwardly,
(b) Advancing the baskets by means of a movable mechanism provided on the tempering line and applying pre-thermal process to the glass product for 30-60 minutes in the temperature range of 250°-350°,
(c) Keeping the glass product in KNO₃ molten salt for duration of 2-8 hours in the temperature range of 400°-475°,
(d) Guiding the basket downwardly at a predetermined angle and discharging the molten salt, provided in the chamber of the glass products, before the salt turning into solid form,
(e) Keeping the glass product in the temperature range of 250°-350° for 30-60 minutes.

In a preferred embodiment of the present invention, in step (c), 250 grams of KNO₃ molten salt is used for each 1 gram of glass.

In another preferred embodiment of the present invention, the subject matter method is used in chemical tempering of glass bottles having wall thickness of at most 2 mm.

In another preferred embodiment of the present invention, the subject matter method is used in chemical tempering of glass cups having wall thickness of at most 0.85 mm.

In another preferred embodiment of the present invention, the subject matter method is used in chemical tempering of glass cups having foot thickness of at most 4.75 mm.

In order to realize all of the abovementioned objects and the objects which are to be deducted from the detailed description below, the present invention is a glass bottle or glass cup which is chemically strengthened by means of the abovementioned method.

In another preferred embodiment of the present invention, in glass cups, the wall thickness is at most 0.85 mm and the foot thickness is at most 4.75 mm.

In another preferred embodiment of the present invention, the wall thickness in glass bottles is at most 2 mm.

In another preferred embodiment of the present invention, the compressive stress after strengthening is between 350 MPa and 550 MPa.

In another preferred embodiment of the present invention, the Vickers hardness value after strengthening is ≥5.8 GPa.

In another preferred embodiment of the present invention, the visible region transmittance value after strengthening is >92%.

### DETAILED DESCRIPTION OF THE INVENTION

In this detailed description, the subject matter chemical tempering method is explained with references to examples without forming any restrictive effect only in order to make the subject more understandable.

The glass household good crystalline composition preferably comprises 15% alkali oxide and 12% earth alkali oxide. According to TS 6500 Crystal Glass Standard, in crystalline glasses, the total of K₂O, PbO, BaO, ZnO oxides shall be 10% or more and the refraction index shall be greater than 1.520. The glass composition, produced within the scope of the present invention and whose resistance is increased, is the crystalline glass composition and it comprises the glass composition given in Table 1 in terms of weight %;

TABLE 1

| Component | Weight % |
|---|---|
| SiO₂ + B₂O₃ | 68-74 |
| Al₂O3 | 0-2 |
| Fe₂O3 | 0-0.02 |
| Na₂O | 8.5-12 |
| K₂O | 5-9 |
| CaO | 5-9 |
| MgO | 0-0.5 |
| BaO | 0-4 |
| ZnO | 0-3 |
| TiO₂ | 0-0.05 |
| Sb₂O₃ | 0-0.25 |
| Er₂O₃ | 0-0.05 |

The refraction index of the glass composition, which is given in Table 1, is 1.52 or more and/or the total (K₂O+BaO+ZnO+PbO) ingredient is 10% or more.

The crystal glass composition in Table 1 which is compliant to TS 6500 crystal glass standard is molten in furnace, and glass cups, having feet and walls with the below mentioned thicknesses, are obtained by using this glass.
thin walled cup→≤0.85 mm
thin feet cup→≤4.75 mm
thin walled bottle→≥2 mm

By taking molten glass drop through the gathering hole of the furnace, shaping footed cup, cup, bottle, etc., is realized manually and/or automatically by means of known methods like blowing and/or drawing methods in machines. Afterwards, the products are cooled in a controlled manner.

Thin walled glass bottle and thin walled and thin footed glass cups, having crystalline class glass composition produced in the abovementioned manner, are washed with demineralized water, dried and placed into stainless steel baskets such that their chambers face upwardly in order to be chemically tempered by means of the subject matter method named as Ion Shielding Technology. The basket including said glass products firstly enters into 1st compartment of the chemical tempering unit by means of the movable mechanism. The atmosphere temperature of the 1^{st} compartment is at least between 250° and 350°. The glass products are subjected to pre-heating in the 1^{st} compartment between 30 minutes and 60 minutes. The basket including the glass products passes to the 2^{nd} compartment of the chemical tempering unit by means of the movable mechanism. The basket including the glass products passing to the 2^{nd} compartment is immersed into the molten KNO₃ salt, having a temperature between 400° C. and 475° C., by means of the movable mechanism. Since the chamber of the glass products is placed to the basket in a manner facing upwardly, both the inner surface and the outer surface of the chamber contact the molten salt. In the 2^{nd} compartment, there is at least 250 grams of molten salt for each 1 gram of glass.

The basket including glass products is advanced towards the 3^{rd} compartment by using movable mechanism in the molten salt provided in the 2^{nd} compartment. Since the basket including the glass products moves from the 2^{nd} compartment towards the 3^{rd} compartment, the border of the intermediate surface of the molten salt and the glass products will always be renewed. The duration of staying of the basket, including the glass products, in the 2^{nd} compartment shall be between 1 and 8 hours. The basket, including the glass products, is removed from the molten salt at the end of this duration. At the instant of said removal from the molten salt, the basket, including the glass products, is guided downwardly at a specific angle and the molten salt, provided in the chamber of glass products, is discharged before it turns into solid form.

The basket, including the glass products, passes to the 3^{rd} compartment of the chemical tempering unit by means of the movable mechanism. The atmosphere temperature of the 3^{rd} compartment is between 250° C. and 350° C. The glass products are subjected to final-heating for duration between 30 minutes and 60 minutes in the 3^{rd} compartment.

The glass products removed from the basket are washed with pure water and afterwards, they are washed with demineralized water and dried.

Mechanical tests are applied to the glass products obtained by means of said method and improvements have been observed in the mechanical characteristics of glass products having the ingredient given in Table 1 tempered by means of said method.

The compressive stress of the product obtained by means of the subject matter method has been measured by means of FSM 6000LE surface tension-meter device based on Photo-elasticity theory.

Compressive stress: ˜350 MPa-550 MPa

The thickness of the compressive layer is 15-20 μm

The Vickers hardness measurements of the product obtained by means of the subject matter method have been realized by means of Shimadzu Model-M Micro hardness device by using the following parameters:

Load: 50 g with fixed loading speed

Waiting duration: 15 s

Number of notches: 10

Device used for notch analysis: Bruker Counter GT-K1 optic profilometer

Room temperature: 23±1° C.

Relative humidity: 50-60%

According to the analysis made, the detected hardness value increases by at least 0.5 GPa after strengthening.

Indentation crack formation resistance has been examined by using Shimadzu Model-M Vickers micro-hardness test device before and after strengthening. Notch has been formed with waiting duration of 15 seconds on the surface of the glass products. The loads applied onto the surface of glass products are as follows: 0.25 N (25 g), 0.49 N (50 g), 0.98 N (100 g), 1.96 N (200 g), 2.94 N (300 g), 4.90 N (500 g). 10 notches have been formed onto the surface of glass products for each load. In case crack formation begins in at least 2 of the 4 corners, it has been accepted that the notch, formed on the surface, creates crack. The notch and crack images have been taken with the same zooming by using optic microscope. As a result of the study made, while crack has been formed on the surface with 50 g (0.49 N) load before strengthening, and no crack has been formed with 50 g (0.49 N) after strengthening. Crack has occurred as a result of at least 100 g (0.98 N) load.

The surface scratching test has been realized by means of the NANOVEA M1 Nano-Module nano-mechanical test device by using the following parameters:

Type: Sphero-conical 90°, diameter 5 μm

Load: 50 mN

Speed: 1 mm/minute

Length of scratch: 500 μm

Number of scratches: 10

Device used for scratch depth measurement: Bruker Counter GT-K1 optic profilometer

Room temperature: 23±1° C.

Relative humidity: 50-60%

According to the analysis made, the detected average scratch depth values are as follows:

Before strengthening: 0.84 μm±0.02

After strengthening: 0.54 μm±0.03

In the bending test, the foot of the footed glass cups is fixed from the table and its body is bent under a specific load. The number of tested samples is 10. The detected bending values are as follows:

Before strengthening: <6°→foot has been separated from body

After strengthening: >12° (no separation has been observed at 12° and lower) The impact resistances of the inlet and body of the glass bottles and the impact resistances of the inlet, body and table of the footed glass cups have been tested according to the standard with number DIN52295 (Testing of glass—Pendulum impact test). The number of samples subjected to test is 10. The increase obtained in the detected average impact resistance values is as follows:

Inlet Region:

After strengthening: 25-35% increase

Body Region:

After strengthening: 25-35% increase

Table:

After strengthening: approximately 2 folds

The resistances of the glass products against breakage due to falling have been tested by providing free fall. The number of tested samples is 10. After strengthening, the falling distance where no breakage has been observed has increased by at least 10 cm.

No change has been observed in the optic characteristics of the product before and after strengthening. UV-Vis spectroscopy method has been used for searching the effect of potassium ion exchange on optic transmission of glasses in range of 1 nm between wavelengths of 200 nm and 2500 nm. The searches have been realized by means of a tungsten lamp and at room temperature by using Perkin Elmer Lambda 950 UV-Vis spectrophotometer. In glass household goods, no color change has been observed after the chemical tempering process. For all samples chemically tempered, the UV-Vis spectroscopic measurements has shown that optic transmission has been obtained approximately in a fixed manner in the vicinity of 92% of the visible region transmittance.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

1-11. (canceled)

12. A reinforcing method developed for use in glass cup with wall thickness of at most 0.85 mm and with thin walled complex shapes in crystalline structure and comprising SiO₂+B₂O₃ between 68-74% by weight; Al₂O₃ between 0-2% by weight; Fe₂O₃ between 0-0.02% by weight; Na₂O between 8.5-12% by weight; K₂O between 5-9% by weight; CaO between 5-9% by weight; MgO between 0-0.5% by weight; BaO between 04% by weight; ZnO between 0-3% by weight; % TiO₂ between 0-0.05% by weight; Sb₂O₃ between 0-0.25% by weight and Er₂O₃ between 0-0.05% by weight, the method comprising:
(a) cleaning the glass product which is to be tempered and placing and fixing into the baskets such that the chambers thereof face upwardly;
(b) advancing the baskets along the tempering line and applying pre-thermal process to the glass product for 30-60 minutes between temperatures 250° and 350°;
(c) maintaining the glass product in KNO₃ melt salt between 2 and 8 hours between temperatures 400° and 475°;
(d) guiding the basket downwardly by means of a predetermined angle and discharging the melt salt, which exists in the glass product chamber, without passing to solid state;
(e) maintaining the glass product between 30 and 60 minutes between temperatures 250 and 350 and using 250 grams of KNO₃ melt salt for each 1 gram in step (c), wherein the glass products are movable inside the melt salt.

13. The reinforcing method for glass cup by means of a chemical tempering technology according to claim 12, wherein said method is used in chemical tempering of glass cup where the wall thickness is at most 0.85 mm.

14. The reinforcing method for glass cup by means of a chemical tempering technology according to claim 12, wherein said method is used in chemical tempering of glass cup where the foot thickness is at most 4.75 mm.

15. The reinforcing method for glass cup by means of a chemical tempering technology according to claim 12, wherein Vickers hardness value in the glass cup and glass bottles increases at least by 0.5 GPa.

16. A glass cup reinforced by means of chemical tempering by the method according to claim 12.

17. The glass cup according to claim 16, wherein the pressure tension after reinforcement is between 350 MPa and 550 MPa.

18. The glass cup according to claim 16, wherein the visible region transmittance value after reinforcement is ≥92%.
